(19) United States
(12) Patent Application Publication
(10) Pub. No.: US 2010/0091368 A1
(43) Pub. Date: Apr. 15, 2010

(54) Stereographic imaging device using two lcd panel having same polarizing angle

(75) Inventors: Jung Hoi Kim, Gwangju (KR); Hoi Jin Ha, Seoul (KR)

Correspondence Address: THE NATH LAW GROUP, 112 South West Street, Alexandria, VA, 22314, US

(73) Assignee: REDROVER CO., LTD., GYEONGGI-DO (KR)

(21) Appl. No.: 12/310,793

(22) PCT Filed: May 10, 2007
(86) PCT No.: PCT/KR2007/002323

§ 371 Date: Mar. 6, 2009

(30) Foreign Application Priority Data
Sep. 8, 2006 (KR) 10-2006-0086677

(51) Int. Cl. G02B 27/26

(52) U.S. Cl. 359/465

(57) ABSTRACT

The present invention discloses a stereoscopic imaging device, including a first display panel having a front surface to which a first front polarization filter having a polarization angle of 45 degrees is attached, and a rear surface to which a first rear polarization filter having a polarization angle of 135 degrees is attached; a second display panel disposed at an angle of 90 degrees with respect to the first display panel, wherein the second display panel has a front surface to which a second front polarization filter having a polarization angle of 45 degrees is attached and a rear surface to which a second rear polarization filter having a polarization angle of 135 degrees is attached; and a half mirror disposed at an angle of 45 degrees with respect to the first display device and the second display device between the first display device and the second display device.

### TECHNICAL FIELD

The present invention relates to a stereoscopic imaging device, and more particularly, to a stereoscopic imaging device with a need for a process of attaching polarization sheets of LCD panels again after the polarization sheets are detached.

### BACKGROUND ART

A stereoscopic imaging device can be largely classified into a stereoscopic method and an autostereoscopic method. The autostereoscopic method is a method of dividing left and right images spatially at a viewer's eye position and outputting the images.

Representative examples of the autostereoscopic method include a lenticular method and a barrier method. The autostereoscopic method is very convenient because it does not use glasses, but has a phenomenon in which a stereoscopic image is interrupted when moving left and right and forward and rearward. The autostereoscopic method is also disadvantageous in that resolutions are inevitably lowered since a composed left and right image is output using one display.

The stereoscopic method is disadvantageous in that glasses serving as an optical filter must be worn, but is advantageous in that it is excellent in comparison with the autostereoscopic method in terms of the viewing angle or resolutions.

Although stereoscopic imaging devices of various stereoscopic methods have been proposed, most of them use a polarization method. In the prior art, of the stereoscopic methods, a method in which position limits are relatively free, the highest resolution is supported, and two CRT monitors and a half mirror are used as shown in FIG. 1 was used a lot.

This method employs two CRT monitors one of which is for the left eye and the other of which is for the right eye. The method is configured to output picture signals captured by the CRT monitors and combine left and right images to the front through the half mirror, so that a stereoscopic image can be enjoyed using polarized glasses.

FIG. 1 is a view illustrating a construction of a conventional stereoscopic imaging device employing two CRT monitor.

Referring to FIG. 1, the conventional stereoscopic imaging device employing the two CRT monitors includes two CRT monitors 10, 20, polarization filters 11, 21 disposed in front of the CRT monitors 10, 20, respectively, and a half mirror 30 disposed at an angle of 45 degrees with respect to the front side of each of the monitors 10, 20 between the two CRT monitors 10, 20.

In the stereoscopic imaging device constructed above, the following two requirements must be met.

One of the requirements is that a phase difference of a polarization film adhered to each monitor must be 90 degrees, and the other of them is that an image mirror function for turning over left and right sides in order to correct an image must be implemented in an input signal stage because an image on a lower side is output by the half mirror with the left and right sides changed.

This method using the two monitors is advantageous in that a high-resolution stereoscopic image without image loss can be seen since left and right images are output from the respective monitor and combined in the space.

However, this method is disadvantageous in that it has a very large volume because the CRT monitors are used.

In order to supplement the disadvantage of the large volume due to the use of the conventional CRT monitors, a stereoscopic imaging device using two Thin Film Transistor Liquid Crystal Displays (TFT-LCD) having self-polarization filters attached thereto was proposed. The TFT-LCD is one of the widely used display devices in the field of flat displays since it enables direct IC driving because of low consumption power of several to several tens of □/□ and a low voltage operation and it is thin and light and can have a large-sized screen. However, most LCDs have the polarization filter attached thereto and are therefore problematic in that they do not satisfy the polarization orthogonality condition in which the phase difference of the polarization film attached to each monitor must be 90 degrees.

In order to solve the problems, applications regarding a variety of methods were filed. Japanese Patent Application no. 1996-116679 discloses a stereoscopic imaging device in which a liquid crystal display device having a polarization direction of a vertical axis x is a ‘normally white type’ and a liquid crystal display device having a polarization direction of a horizontal axis y is a ‘normally black type’.

The normally white type is of a type in which light can transmit in a normal state where voltage is not supplied to liquid crystal, and the normally black type is of a type in which light can transmit when voltage is supplied to liquid crystal.

The reason why different types of the liquid crystal display devices are used is that mutual perpendicularity could not be accomplished between types in which polarization directions of polarization filters in the existing liquid crystal display device are different. If different types of the liquid crystal display devices are used as described above, there are disadvantages in that a driving method is complicated and a lot of power consumption is needed because the two liquid crystal display devices must be switched in opposite directions. Furthermore, the normally white type and the normally black type have different output characteristics. For example, the normally black type has a low contrast ratio due to the occurrence of light leakage when a light source having a wide wavelength range is used as rear-surface light and therefore is problematic in that the picture quality of left and right images has a different characteristic.

As a method for solving the problem in which the picture quality of left and right images has a different characteristic, Korean Patent Application No. 1999-0049331 was filed. In this patent application, an attempt was made to prevent a reduction of a three-dimensional effect caused by the picture quality difference of left and right images, which occurs due to the use of LCD panels with different characteristics, so as to produce orthogonally polarized light. In other words, in order for polarization directions to be vertical to each other while using two sheets of the same normally black types as LCD panels, polarization filters on both sides of one of liquid crystal display devices is detached, and rotated 90 degrees in the same direction and then attached again.

However, this method is advantageous in that it uses the same panel, but cannot obtain an optimal design and performance of an original liquid crystal panel and, in even worse cases, may have a detrimental result in which an image output itself may become problematic because only the front and rear polarization filters are detached and then attached again at an angle of 90 degrees with no regard for the characteristics of the existing liquid crystal.

Furthermore, since the process of attaching the polarization sheet to the panel again after the polarization sheet attached to the panel is detached must be performed, a problem arises because a process of fabricating a 3D monitor is complicated that much.

### DISCLOSURE OF INVENTION

### Technical Problem

The present invention has been made to solve the problems, and an object of the present invention is to provide a stereoscopic imaging device in which original polarization sheets are used as they are without attaching two panels having the same polarization angle to the polarization sheets again.

### Technical Solution

To achieve the above object, a construction of the present invention includes a first display panel having a front surface to which a first front polarization filter having a polarization angle of 45 degrees is attached, and a rear surface to which a first rear polarization filter having a polarization angle of 135 degrees is attached; a second display panel disposed at an angle of 90 degrees with respect to the first display panel, wherein the second display panel has a front surface to which a second front polarization filter having a polarization angle of 45 degrees is attached and a rear surface to which a second rear polarization filter having a polarization angle of 135 degrees is attached; and a half mirror disposed at an angle of 45 degrees with respect to the first display device and the second display device between the first display device and the second display device.

In a preferred embodiment, the first display panel and the second display panel have the front surfaces to which the first front polarization filter and the second front polarization filter respectively having a polarization angle of 135 degrees are attached, respectively, and the rear surfaces to which the first rear polarization filter and the second rear polarization filter respectively having a polarization angle of 45 degrees are attached, respectively.

In a preferred embodiment, the first display panel and the second display panel respectively include a LCD panel.

In a preferred embodiment, a picture signal input to the second display panel includes a picture signal having an image whose left and right are reversed with respect to an image input to the first display panel.

To accomplish the above object, another construction of the present invention includes a first display panel; a first polarization filter disposed in parallel to a front surface of the first display panel and having a polarization angle of 45 degrees; a second display panel disposed at an angle of 90 degrees with respect to the first display panel; a second polarization filter disposed in parallel to a front surface of the second display panel and having a polarization angle of 45 degrees; and a half mirror disposed at an angle of 45 degrees with respect to the first display panel and the second display panel between the first display panel and the second display panel.

In a preferred embodiment, the first polarization filter and the second polarization filter respectively have a polarization angle of 135 degrees.

In a preferred embodiment, the first display panel and the second display panel respectively include an organic EL display panel or a PDP panel.

In a preferred embodiment, a picture signal input to the second display panel includes a picture signal having an image whose left and right are reversed with respect to an image input to the first display panel.

### ADVANTAGEOUS EFFECTS

According to the present invention, display panels that were produced in a factory and supplied are used as they were without a process of attaching polarization filters to the display panels again after the polarization filters attached to the panels are detached. Accordingly, there is an advantage in that a process of fabricating a stereoscopic imaging device can be simplified.

### BRIEF DESCRIPTION OF THE DRAWINGS

FIG. 1 is a view illustrating a construction of a conventional stereoscopic imaging device employing two CRT monitor;

FIG. 2 is a view illustrating a construction of a stereoscopic imaging device according to a first embodiment of the present invention;

FIG. 3 is a view illustrating a structure of LCD panels of FIG. 2; and

FIG. 4 is a view illustrating a construction of a stereoscopic imaging device according to a second embodiment of the present invention.

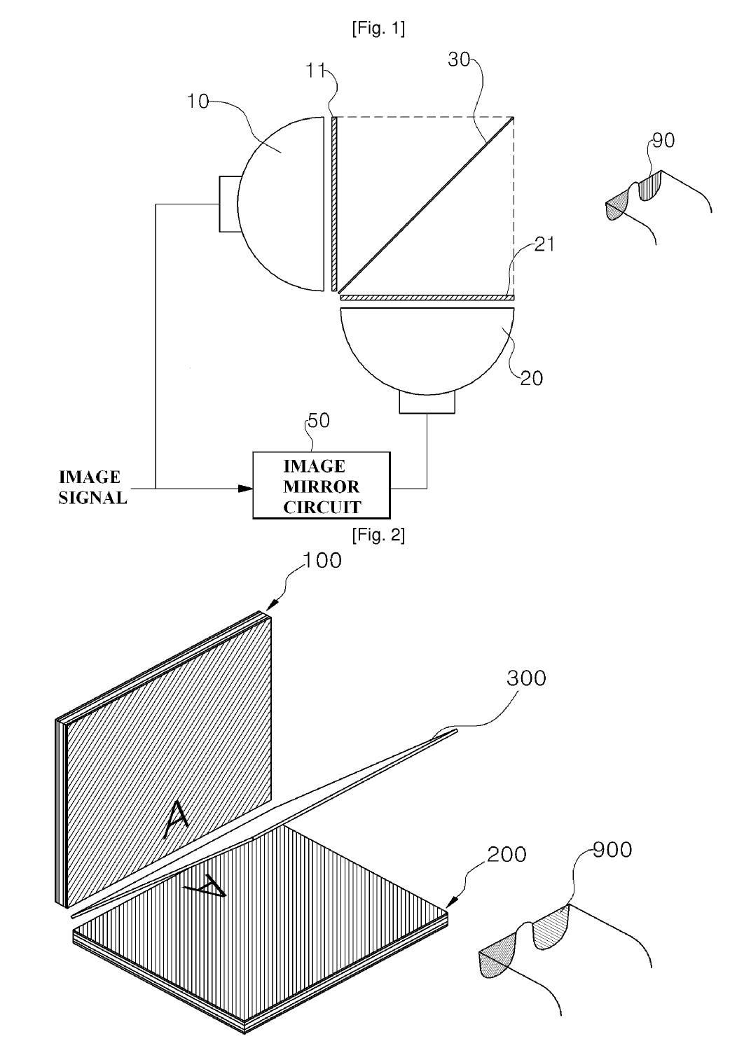

In the drawings according to the present invention, the same reference numerals will be used to refer to the same constituent elements substantially having the same construction and function.

### DESCRIPTION OF REFERENCE NUMERALS OF PRINCIPAL ELEMENTS IN THE DRAWINGS

100: first display panel 200: second display panel
710: third display panel 720: fourth display panel
111: first front polarization filter 112: first rear polarization filter
121, 122, 221, 222: electrode glass sheet
130, 230: liquid crystal layer 211: second front polarization filter
212: second rear polarization filter 300: half mirror
810, 820: polarization filter 900: polarized glasses

### BEST MODE FOR CARRYING OUT THE INVENTION

The present invention will now be described in detail in connection with embodiments with reference to the accompanying drawings.

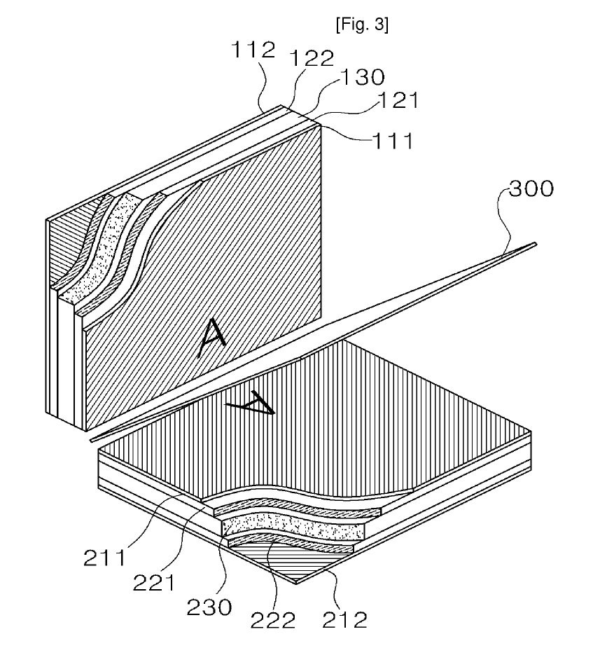

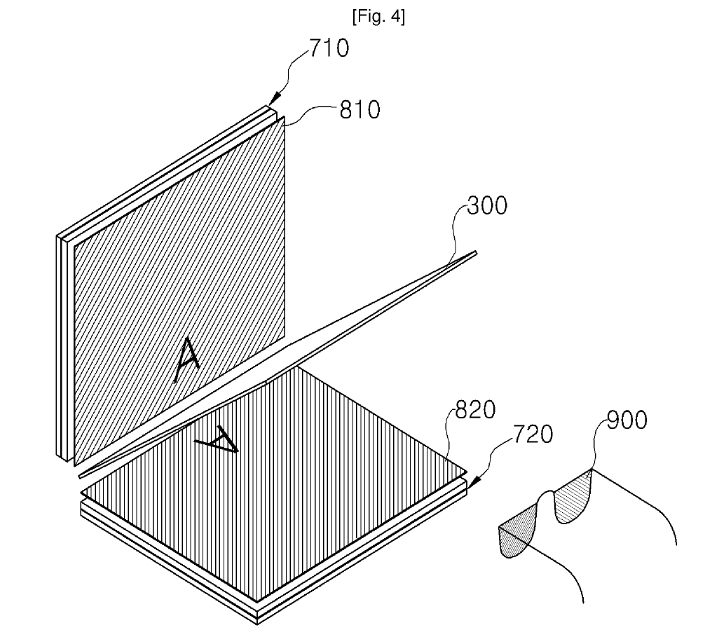

FIG. 2 is a view illustrating a construction of a stereoscopic imaging device according to a first embodiment of the present invention. FIG. 3 is a view illustrating a process of fabricating a second display panel of FIG. 2.

Referring to FIG. 2, the stereoscopic imaging device according to a first embodiment of the present invention includes a first display device 100, a second display device 200, a half mirror 300, and a polarized glasses 900. The first display panel 100 and the second display panel 200 include LCD panels in which polarization filters having a polarization angle difference of 90 degrees are attached to both surfaces of an electrode glass sheet.

Referring to FIG. 3, the first display panel 100 and the second display panel 200 include electrode glass sheets 121, 122 and 221, 222 respectively attached to front and rear surfaces of liquid crystal layers 130, 230, respectively, and polarization filters 111, 112 and 211, 212 respectively attached to outer surfaces of the electrode glass sheets 121, 122 and 221, 222, respectively.

The first display panel 100 has a front surface to which a first front polarization filter 111 having a polarization angle of 45 degrees is attached, and a rear surface to which a first rear polarization filter 112 having a polarization angle of 135 degrees is attached. The second display panel 200 is disposed at an angle of 90 degrees with respect to the first display panel 100. The second display panel 200 has a front surface to which a second front polarization filter 211 having a polarization angle of 45 degrees is attached, and a rear surface to which a second rear polarization filter 212 having a polarization angle of 135 degrees is attached.

The half mirror 300 is disposed at an angle of 45 degrees with respect to the first display device 100 and the second display device 200 between the first display device 100 and the second display device 200.

The stereoscopic imaging device constructed above according to the first embodiment use two identical LCD panels. The panels that were produced in a factory and supplied are used as they are without a process of attaching the polarization filters to the panels again after the polarization filters attached to the panels are detached.

In the first embodiment of the present invention, an image mirror circuit (not shown) (that is, a circuit for reversing the left and right of an image) is connected to a picture signal input stage of the second display panel.

The first display panel 100 and the second display panel 200 are disposed in such a manner that their bottom surfaces are brought in contact with each other. Accordingly, the left and right of images respectively displayed on the first display panel 100 and the second display panel 200 are opposite to each other. In other words, an image on the left side of a screen of the first display panel 100 is displayed on the right side of a screen of the second display panel 200.

Therefore, it is necessary to reverse the left and right of an image of one of the first display panel 100 and the second display panel 200 using the image mirror circuit. A picture signal input to the second display panel 200 through the image mirror circuit becomes a picture signal having an image whose left and right are reversed with respect to the image input to the first display panel 100.

In the first embodiment of the present invention, an example in which the polarization filters having a polarization angle of 45 degrees are attached to the front surfaces of the first display panel 100 and the second display panel 200, respectively, has been described. However, the first display panel 100 and the second display panel 200 may have the front surfaces to which the first front polarization filter and the second front polarization filter respectively having a polarization angle of 135 degrees are attached, respectively, and the rear surfaces to which the first rear polarization filter and the second rear polarization filter respectively having a polarization angle of 45 degrees are attached, respectively. The effect obtained by using two identical LCD panels without an additional process of attaching filters is the same.

### MODE FOR THE INVENTION

FIG. 4 is a view illustrating a construction of a stereoscopic imaging device according to a second embodiment of the present invention.

Referring to FIG. 4, the stereoscopic imaging device according to a second embodiment of the present invention includes a third display panel 710, a first polarization filter 810, a fourth display panel 720, a second polarization filter 820, and a half mirror 300. The third display panel 710 and the fourth display panel 720 employ an organic EL display panel or a PDP in which a polarization sheet is not included in a display panel.

The fourth display panel 720 is disposed at an angle of 90 degrees with respect to the third display panel 710.

The first polarization filter 810 is disposed in parallel to a front surface of the third display panel 710, and the second polarization filter 820 is disposed in parallel to a front surface of the fourth display panel 720. The first polarization filter 810 and the second polarization filter 820 respectively have a polarization angle of 45 degrees, and have the same polarization angle.

The half mirror 300 is disposed at an angle of 45 degrees with respect to the third display panel 710 and the fourth display panel 720 between the third display panel 710 and the fourth display panel 720.

In the second embodiment of the present invention, an image mirror circuit (not shown) (that is, a circuit for reversing the left and right of an image) is connected to a picture signal input stage of the fourth display panel 720.

In the second embodiment of the present invention, an example in which the polarization filter having a polarization angle of 45 degrees is used has been described. However, a polarization filter a polarization angle of 135 degrees may also be used.

Although the constructions and operations of the present invention have been described with reference to the drawings, they are only illustrative. It is evident that various modifications and additions are possible without departing from the technical spirit and scope of the present invention.

The stereoscopic imaging device constructed above according to the present invention can be used as a 3D monitor of a computer and can also be used in a stereoscopic image display device of game machine or a variety of 3D display device.

Although the constructions and operations of the present invention have been described with reference to the drawings, they are only illustrative. It is evident that various modifications and additions are possible without departing from the technical spirit and scope of the present invention.

### INDUSTRIAL APPLICABILITY

The present invention relates to a stereoscopic imaging device. Display panels that were produced in a factory and supplied are used as they were without a process of attaching polarization filters to the display panels again after the polarization filters attached to the panels are detached. Accordingly, the present invention can simplify a process of fabricating a stereoscopic imaging device and therefore can be widely utilized in the field of an imaging device.

1. A stereoscopic imaging device, comprising:
a first display panel having a front surface to which a first front polarization filter having a polarization angle of 45 degrees is attached, and a rear surface to which a first rear polarization filter having a polarization angle of 135 degrees is attached;
a second display panel disposed at an angle of 90 degrees with respect to the first display panel, wherein the second display panel has a front surface to which a second front polarization filter having a polarization angle of 45 degrees is attached and a rear surface to which a second rear polarization filter having a polarization angle of 135 degrees is attached; and
a half mirror disposed at an angle of 45 degrees with respect to the first display device and the second display device between the first display device and the second display device.

2. The stereoscopic imaging device of claim 1, wherein the first display panel and the second display panel have the front surfaces to which the first front polarization filter and the second front polarization filter respectively having a polarization angle of 135 degrees are attached, respectively, and the rear surfaces to which the first rear polarization filter and the second rear polarization filter respectively having a polarization angle of 45 degrees are attached, respectively.

3. The stereoscopic imaging device of claim 1 or 2, wherein the first display panel and the second display panel respectively include a LCD panel.

4. The stereoscopic imaging device of claim 3, wherein a picture signal input to the second display panel includes a picture signal having an image whose left and right are reversed with respect to an image input to the first display panel.

5. A stereoscopic imaging device, comprising:
a third display panel;
a first polarization filter disposed in parallel to a front surface of the third display panel and having a polarization angle of 45 degrees;
a fourth display panel disposed at an angle of 90 degrees with respect to the third display panel;
a second polarization filter disposed in parallel to a front surface of the fourth display panel and having a polarization angle of 45 degrees; and
a half mirror disposed at an angle of 45 degrees with respect to the third display panel and the fourth display panel between the third display panel and the fourth display panel.

6. The stereoscopic imaging device of claim 5, wherein the first polarization filter
and the second polarization filter respectively have a polarization angle of 135 degrees.

7. The stereoscopic imaging device of claim 5 or 6, wherein the third display panel and the fourth display panel respectively include an organic EL display panel.

8. The stereoscopic imaging device of claim 7, wherein a picture signal input to the fourth display panel includes a picture signal having an image whose left and right are reversed with respect to an image input to the third display panel.

9. The stereoscopic imaging device of claim 5 or 6, wherein the third display panel and the fourth display panel respectively include a PDP panel.

10. The stereoscopic imaging device of claim 9, wherein a picture signal input to the fourth display panel includes a picture signal having an image whose left and right are reversed with respect to an image input to the third display panel.
